(19) United States
(12) Patent Application Publication
(10) Pub. No.: US 2021/0121799 A1
(43) Pub. Date: Apr. 29, 2021

(54) CLARIFICATION OF COLLOIDAL SUSPENSIONS

(71) Applicant: SIGNET AGGREGATES, LLC, Casper, WY (US)

(72) Inventors: Robert Delane Baldwin, Casper, WY (US); Kyle Shawn True, Casper, WY (US)

(21) Appl. No.: 17/141,638

(22) Filed: Jan. 5, 2021

Related U.S. Application Data
(63) Continuation-in-part of application No. 16/396,477, filed on Apr. 26, 2019, now Pat. No. 10,889,744.

(51) Int. Cl. B01D 21/00; E21B 21/01

(52) U.S. Cl. CPC B01D 21/0042; E21B 21/01; B01D 21/0075; B01D 21/0018

(57) ABSTRACT

A process mechanically breaks colloidal suspension bonds with the surrounding fluids through high energy impact with a stationary plate or a colliding fluid stream. The fluid with a colloidal suspension is pumped through one or more ⅛″ to 3″ nozzles to collide with either a stationary plate in an impact chamber at high velocity, another similar or different fluid stream, or both another fluid stream and an impact plate. The process breaks the bonds maintaining the colloidal suspension, disassociates these materials, and allows for gravity or chemical separation of the previously colloidal particles from the fluid. The process can separate colloidal particles from a liquid medium through pressurization followed by high energy impact and rapid release.

### CROSS-REFERENCE TO RELATED APPLICATIONS

This application is a continuation-in-part of U.S. patent application Ser. No. 16/396,477, filed Apr. 26, 2019, the contents of which are herein incorporated by reference.

### BACKGROUND OF THE INVENTION

### 1. Field of the Invention

Embodiments of the invention relates generally to liquid purification methods and apparatus. More particularly, the invention relates to methods and apparatus for the clarification of colloidal suspensions.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Colloidal suspensions render many fluids unusable as the colloidal materials change the properties of the host fluid substantially. Cooking oils, motor oils, hydraulic oils, drilling muds, mine tailings ponds and other fluids become unusable as colloidal suspensions develop within them. Re-use of the fluids may become impractical or disposal may become difficult, as in the case of many mine tailing ponds.

Conventional methods for the clarification of colloidal suspensions include (1) mechanical centrifugal separation, where the use of centrifuges overcome capillary and adhesive forces between the fluid and the colloidal particles; (2) mechanical filtration systems where some particles are filtered out but often require large filters and the filters often become plugged; (3) evaporation ponds; (4) chemical methods where chemicals are used to separate solids from their host fluid using flocculants which can, however, present further contamination and remediation challenges; and (5) thermal separation where boiling of fluids leaves a “reduction” that contains the colloidal and other solids, but is often impractical.

These conventional methods can take substantial time and often incur significant expense. Prior methods often result in environmentally damaging byproducts or an unsafe work environment. Prior methods are cost limiting or prohibitive. Huge storage reservoirs exist around the world attempting to contain colloidal suspensions of mining fluid the industry considers itself incapable of clarifying, posing life threatening risks to those who live downstream, as witnessed by repeated fatal dam breaches in recent years.

In view of the foregoing, there is a need for improved methods and apparatus for the clarification of colloidal suspensions.

### SUMMARY OF THE INVENTION

Embodiments of the present invention provide a method for clarifying a colloidal suspension comprising impacting a stream of the colloidal suspension with one of an impact plate, one or more additional fluid streams, or the one of more additional fluid streams followed by an impact plate, to form an impacted colloidal suspension; collecting the impacted colloidal suspension; and separating a clarified fluid fraction from the collected impacted colloidal suspension.

Embodiments of the present invention further provide a method for clarifying a colloidal suspension comprising pumping the colloidal suspension through at least one nozzle to create a pressurized colloidal suspension; releasing the pressurized colloidal suspension from the at least one nozzle to create at least one stream of fluid; and impacting the at least one stream of fluid with one of an impact wall and one or more additional streams of fluid to form an impacted colloidal suspension.

Embodiments of the present invention also provide a method for reducing a total suspended solids concentration of a fluid comprising impacting a first stream of the colloidal suspension having a first total suspended solids concentration with either (1) an impact wall, (2) one or more additional fluid streams, or (3) one or more additional fluid streams to form a combined stream and impacting the combined stream into the impact wall, to form an impacted colloidal suspension; collecting the impacted colloidal suspension; and separating a clarified fluid fraction from the collected impacted colloidal suspension, wherein the clarified fluid fraction has a second total suspended solids concentration less than the first total suspended solids concentration.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of an apparatus usable to perform methods according to an exemplary embodiment of the present invention;

FIGS. 2A through 2D illustrate various impact plates usable in various embodiments of the present invention;

FIG. 3 illustrates a schematic representation of another apparatus, with a single pump, usable to perform methods according to an exemplary embodiment of the present invention;

FIG. 4 illustrates a schematic representation of an apparatus, with pumps for each fluid stream, usable to perform methods according to an exemplary embodiment of the present invention;

FIGS. 5A and 5B illustrates a schematic cross-sectional view along line V-V of FIG. 4 (for example), showing nozzles of an apparatus for impacting two (FIG. 5A) or more (FIG. 5B) streams together at an angle, according to an exemplary embodiment of the present invention; and

FIGS. 6A and 6B illustrates a schematic cross-sectional view along line V-V of FIG. 4 (for example), showing nozzles of an apparatus for impacting two (FIG. 6A) or more (FIG. 6B) streams together at an angle, followed by impact of the combined streams onto an impact plate, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an apparatus and process to mechanically break colloidal suspension bonds with the surrounding fluids through high energy impact with a stationary plate or colliding fluid stream. The fluid with a colloidal suspension is pumped through one or more ⅛″ to 3″ nozzles to collide with either a stationary plate in an impact chamber at high velocity, another similar or different fluid stream, or a combination thereof. Specific applications may utilize even smaller or larger nozzles as appropriate for the volume of fluids treated and the pumps available. For example, used cooking oils may use a smaller nozzle and pump to achieve adequate pressurization, depressurization, and impact velocities, while a mine tailings pond might use an even larger pump system and nozzles to achieve adequate parameters for that specific situation. The process breaks the bonds maintaining the colloidal suspension, disassociates these materials, and allows for gravity or chemical separation of the previously colloidal particles from the fluid. The process can separate colloidal particles from a liquid medium through pressurization followed by high energy impact and rapid pressure release.

Typically, a fluid with a colloidal suspension is pumped through one or more nozzles into either a stationary high impact plate, against another high rate fluid stream within a chamber, or through a combination of fluid stream collision followed by impacting the combined stream with an impact plate. Typically, this other high rate fluid stream can be the same fluid with a colloidal suspension therein, however, in some embodiments, this other high rate fluid stream may be a different liquid, such as water, and, in other embodiments, this other high rate fluid stream may be an air stream. When pressure is released, the fluids clarify through gravity separation and some of the fluid volume is clarified of the colloidal mixture. Other clarifying processes could also be used after the high energy impact or collision.

The separation of the colloidal solid from the host liquid, whether sand particles, drill cuttings, or other dust like solid, must overcome the surface tension and electromagnetic forces that have come to dominate the movement of the colloidal solid, rendering gravity negligible. These bonds have never yet been broken in such an efficient way by harnessing fluid flow characteristics and inertia. This breakage of such bonds through this high rate and high impact action is novel and unexpected in a pressure and release scenario such as that harnessed and created by embodiments of the present invention. Impact separation combined with rapid pressure release can provide adequate energy to overcome the aforementioned forces.

Water based drilling mud can pumped through the apparatus described below and then be allowed to gravity separate, sometimes with the addition of a surfactant and sometimes free from any surfactant. Typical initial processing results can reduce colloidal suspensions by ten to twenty five percent, leaving clarified liquids and muds with higher total solid concentrations. Subsequent identical processing operations continue to decrease colloidal suspensions, or to concentrate such suspensions into a decreasing volume of host fluid.

Colloidal suspensions may be removed from other fluids in addition to those discussed herein. For example, hydrocarbon fluids may be treated according to methods of the present invention.

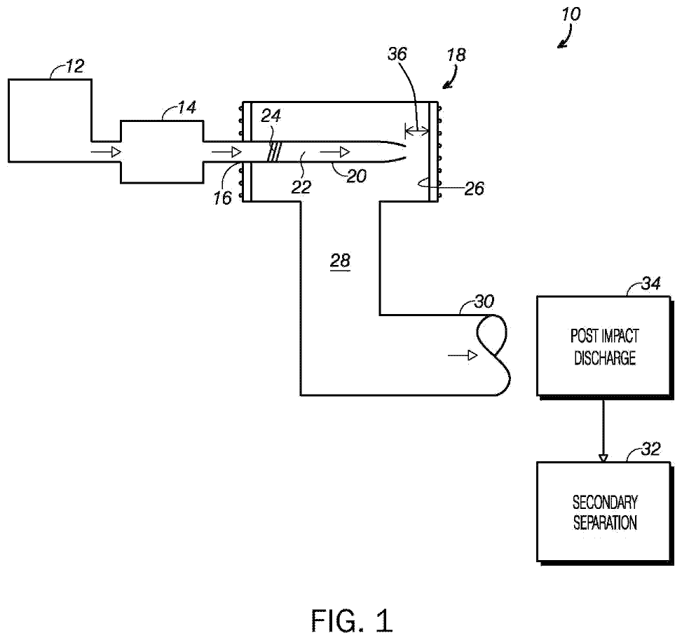

Referring now to FIG. 1, an apparatus 10 can receive a colloidal suspension into a tank 12. This suspension may be pumped, via one or more pumps 14 into an impact chamber 18 and can exit, via a nozzle 20 to strike an impact plate 26. The impacted fluid 34 may exit through an opening 28 in the bottom of the impact chamber 18 and a channel 28 may be located beneath the opening 28 to allow the resulting impacted fluid 34, also referred to as post impact discharge 34, to flow to a secondary separation phase 32, which can include, for example, gravity or chemical separation. In some embodiments, the impacted fluid 34 may be re-introduced into the tank 12 for further impact on the impact plate 26.

The nozzle 20 may have a threaded region 22 that may mate with a threaded region 24 on the output tube 16 from the slurry pump 14. Threaded region 22 may be, for example, a female threaded region and threaded region 24 may be a male threaded region, however, the threads may be reversed within the scope of the present invention. The threaded regions 22, 24 allow the user to easily change the nozzle 20 to a desired diameter and distance 36 away from the impact plate 26, depending on the input colloidal suspension, the desired output, input rate, liquid concentration in the suspension, pump rate, and the like.

In some embodiments, the nozzle 20 may be formed from a 2-inch pipe that narrows to 1.5 inches at its end. The impact chamber 18 may be formed from a 6-inch pipe with the impact plate 26 disposed at a closed end thereof. The end of the nozzle 20 may be disposed a distance 36 from about 1 inch to about 6 inches, typically from about 2 inches to about 4 inches, from the impact plate 26. Of course, the sizes of each component (such as the nozzle 20 and the impact chamber 18) and the distance between the nozzle 20 and the impact plate 26 may vary depending on the particular application.

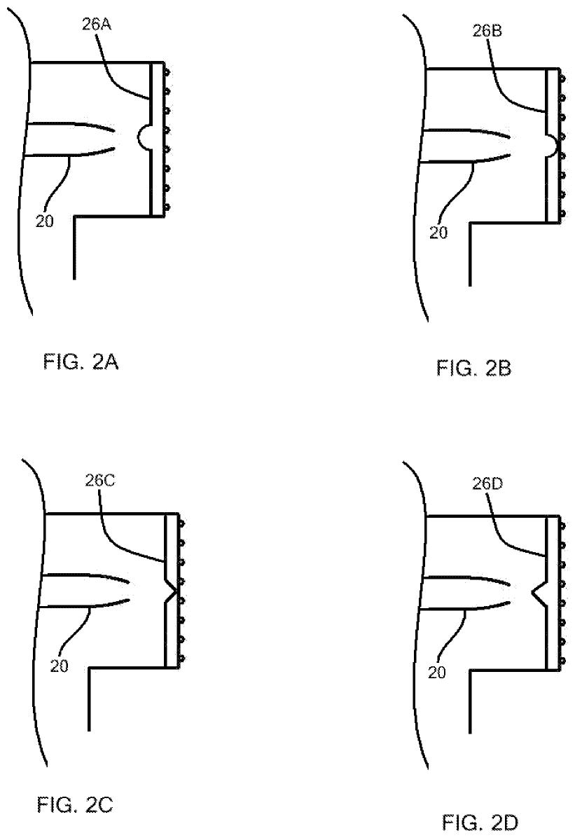

In some embodiments, the impact plate 26 may be a flat plate, as shown in FIG. 1. FIGS. 2A through 2D illustrate other shapes that may be used for receiving the impact of the fluid stream. In other words, instead of flat, the impact plate 26 may include one or more surface imperfections formed therein. For example, in FIG. 2A, a concave arc (or a plurality of concave arcs) may receive a stream from the nozzle 20, in FIG. 2B, a convex arc (or a plurality of convex arcs) may receive a stream from the nozzle 20, in FIG. 2C, a convex cone (or a plurality of convex cones) may receive a stream from the nozzle 20, and in FIG. 2D, a concave cone (or a plurality of concave cones) may receive a stream from the nozzle 20. While these four examples are shown, other shapes may be used for the impact plate, such as flat angled plates, wavy-shaped, tooth-shaped and the like.

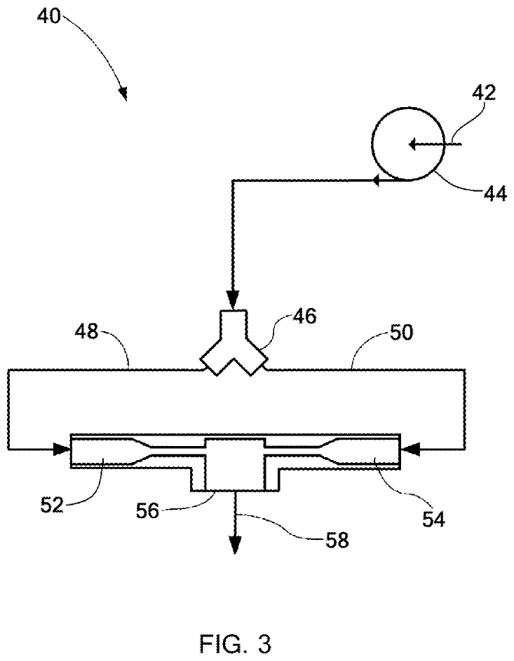

Referring now to FIG. 3, in some embodiments, the colloidal suspension may be impacted by directing two or more streams of the colloidal suspension at each other. An apparatus 40 can include a pump 44 to direct an input fluid 42, such as a colloidal suspension, to a splitter 46 that directs the pumped fluid into feed lines 48, 50. The feed lines 48, 50 direct the pumped fluid into nozzles 52, 54, respectively. The nozzles 52, 54 are directed at each other to cause pressurized fluid from the feed lines 48, 50 to impact each other in an impact chamber 56. The output 58 may be treated, by chemical or gravity separation, for example, to separate out the suspended particles from the liquid.

While the figure shows the nozzles 52, 54 aiming their output streams directly at each other, in some embodiments the output streams of the nozzles 52, 54 may be angled, either horizontally, vertically, or both horizontally and vertically, provided that at least a portion of one nozzle output stream impacts another. Further, while only two nozzles are shown, more than two nozzles may be used, provided that at least a portion of one nozzle output stream impacts another. In other embodiments, two or more nozzles may direct their output streams at each other, while one or more additional nozzles may direct their output at a fixed plate, similar to that described above with respect to FIG. 1.

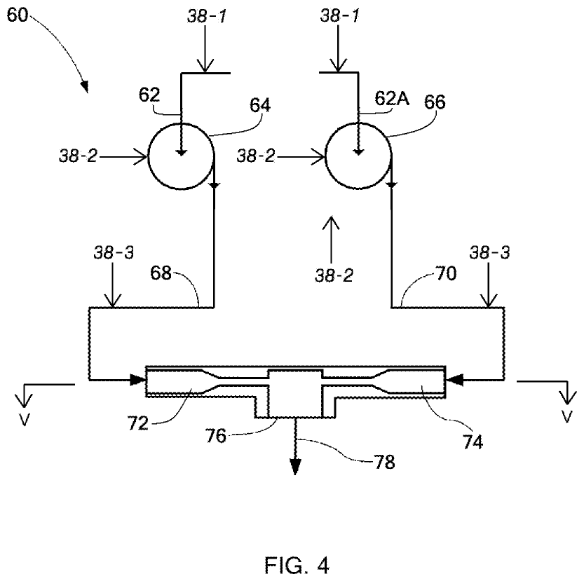

Referring now to FIG. 4, in some embodiments, the colloidal suspension may be impacted by directing two or more streams of the colloidal suspension at each other. An apparatus 60 can include two or more pumps 44, 46 (two are shown in FIG. 4) to direct an input fluid 62, 62A, such as a colloidal suspension, to feed lines 68, 70. The feed lines 68, 70 direct the pumped fluid into nozzles 72, 74, respectively. The nozzles 72, 74 are directed at each other to cause pressurized fluid from the feed lines 68, 70 to impact each other in an impact chamber 76. The output 78 may be treated, by chemical or gravity separation, for example, to separate out the suspended particles from the liquid. The embodiment of FIG. 4 may be used when the input fluids 62, 62A are the same or different. In some embodiments, one pump 64 may be removed and pressurized air may be used as the input fluid 62.

While the figure shows the nozzles 72, 74 aiming their output streams directly at each other, in some embodiments the output streams of the nozzles 72, 74 may be angled, either horizontally, vertically, or both horizontally and vertically, provided that at least a portion of one nozzle output stream impacts another. Further, while only two nozzles are shown, more than two nozzles may be used, provided that at least a portion of one nozzle output stream impacts another. In other embodiments, two or more nozzles may direct their output streams at each other, while one or more additional nozzles may direct their output at a fixed plate, similar to that described above with respect to FIG. 1.

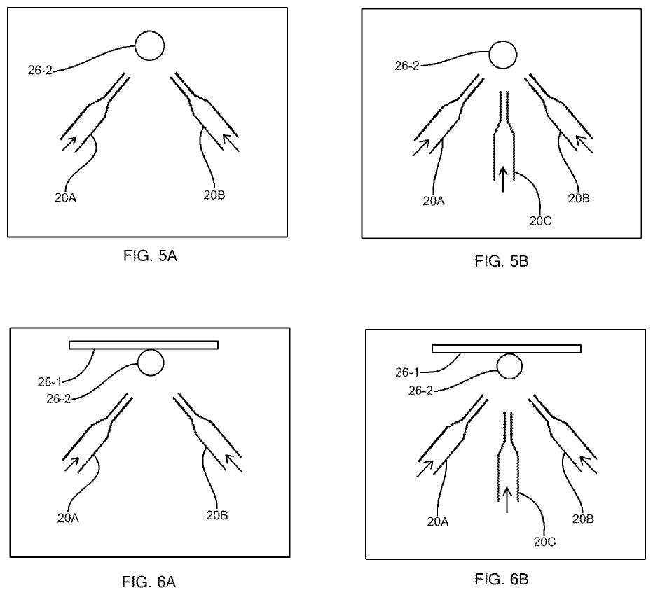

Referring now to FIG. 5A, a first nozzle 20A may be configured to deliver a colloidal fluid stream into a fluid stream from a second nozzle 20B. The fluid stream from the second nozzle 20B may be the same colloidal fluid stream being delivered through the first nozzle 20A, or may be a different fluid, such as water, a hydrocarbon, air, or the like. Typically, nozzles 20A, 20B are configured to have streams that intersect at an angle less than 180 degrees. In some embodiments, as shown in FIG. 5B, a third nozzle 20C may be used, where the fluid stream of the third nozzle 20C may intersect with the streams from nozzles 20A, 20B. Like the fluid stream of the second nozzle 20B, the fluid stream of the third nozzle 20C may be the same or different from the fluids from nozzles 20A and 20B. The fluid stream of the third nozzle 20C may be in the same plane defined by the fluid streams from nozzles 20A and 20B, or may be in a different plane, provided that all three fluid streams intersect at an impact zone 26-2. While three nozzles 20A, 20B, 20C are shown in FIG. 5B, additional nozzles may be used, depending on the application.

Referring now to FIGS. 6A and 6B, the nozzles 20A, 20B and 20C may perform similar to that of FIGS. 5A and 5B. However, an impact plate 26-1 may be disposed adjacent the impact zone 26-2. In some embodiments, the impact of the fluid streams may occur at the impact plate 26-1, while in other embodiments, the impact of the fluid streams may occur at a distance away from the impact plate 26-1, where the combined fluid streams continue to impact the impact plate 26-1.

### EXAMPLE

A colloidal suspension was taken from standard water based oilfield drilling mud. Attempts by the operator prior to collection to clarify and reuse this fluid on repeated drilling operations have left it with colloidal suspensions that the operator was not able to remove, and these colloidal suspensions make the fluid unusable by density and other measures.

The fluids contained total suspended solids of 129,000 mg/L. This fluid was processed through the devices described above at 80 psi with a variety of configurations, including, but not limited to passing through a 1¼″ nozzle to a fixed plate, and passing through multiple 1¼″ nozzles whose flow was directed at each other as per the device specifications. The resulting post processing product was allowed to settle and to vertically gravity separate for approximately 24 hours.

Samples were taken from the processed fluids at approximately 6″, 18″, 30″, and 40″ of depth from a container 42″ in depth. Those samples showed total suspended solids (TSS) levels of 7 mg/L, 57,500 mg/L, 127,000 mg/L, and 166,000 mg/L, respectively.

Clearly, the processing of the colloidal suspension according to processes of the present invention results in the ability to gravity separate a clarified fluid from the colloidal suspension that may be re-used, while the remaining waste product is minimized. In some embodiments, the clarified fluid has a total dissolved solid concentration of at least 25 percent less than the initial colloidal suspension and, in some embodiments, at least 50 percent less total dissolved solids.

The processes according to embodiments of the present invention were developed for clarification of oil field muds and mine tailings piles but could easily clarify used motor oils, cooking oils or the like. Water based cuttings are a challenge to remediate on a rig site and tailings ponds present a risk to many downstream villages worldwide. While considering these problems, the methods of the present invention were devised for clarification of such fluids.

These processes can be used with varying input fluid rates, solid particle sizes, and nozzle sizes to optimize the colloidal contaminant removal. Temperature variations could increase component separation. The stationary impact plate and impact chamber could be optimized per input material such as by modifying the impact angle, impact plate design, or distance of the impact plate from the nozzle. The colliding fluid streams could be optimized by varying the impact angle, the distance of separation of the nozzles, and the number of nozzles and fluid streams. Secondary contaminant and media separation (after the high energy impact) may vary by input material. Variation in control and measurement of each item listed above can modify the process improvement and optimization. Surfactants or other chemicals modifying the contact angle of the bonds creating the colloidal suspension may enhance the clarification of the base fluids. Of course, the colloidal suspensions may be free from any surfactants or other added chemicals.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for clarifying a colloidal suspension, comprising:
impacting a stream of the colloidal suspension with one of an impact plate, one or more additional fluid streams, or the one of more additional fluid streams followed by an impact plate, to form an impacted colloidal suspension;
collecting the impacted colloidal suspension; and
separating a clarified fluid fraction from the collected impacted colloidal suspension.

2. The method of claim 1, wherein the impact plate has a surface that is either flat or includes one or more surface imperfections formed therein.

3. The method of claim 1, wherein a first stream of the colloidal suspension is impacted against a second stream of the colloidal suspension.

4. The method of claim 1, wherein a first stream of the colloidal suspension is impacted against a second stream of a different fluid.

5. The method of claim 3, wherein an angle of the first stream and the second stream is less than 180 degrees.

6. The method of claim 3, further comprising impacting the first stream and the second stream with at least one additional stream.

7. The method of claim 1, wherein the step of separating includes gravity separation.

8. The method of claim 1, wherein the colloidal suspension is oil drilling mud.

9. The method of claim 1, wherein the clarified fluid has fewer total dissolved solids as compared with the colloidal suspension.

10. The method of claim 9, wherein the clarified fluid has at least 25 percent less total dissolved solids as compared with the colloidal suspension.

11. The method of claim 1, further comprising pumping the colloidal suspension through a nozzle to create a pressurized colloidal suspension.

12. The method of claim 10, further comprising releasing the pressurized colloidal suspension from the nozzle to release the pressure therefrom.

13. The method of claim 10, wherein a tip of the nozzle has a diameter smaller than the nozzle to create the pressurized colloidal suspension.

14. A method for clarifying a colloidal suspension, comprising:
pumping the colloidal suspension through at least one nozzle to create a pressurized colloidal suspension;
releasing the pressurized colloidal suspension from the at least one nozzle to create at least one stream of fluid; and
impacting the at least one stream of fluid with one of an impact wall and one or more additional streams of fluid to form an impacted colloidal suspension.

15. The method of claim 14, further comprising:
collecting the impacted colloidal suspension; and
separating a clarified fluid from the collected impacted colloidal suspension.

16. The method of claim 14, wherein the at least one stream of fluid is impacted with one or more additional streams of form the impacted colloidal suspension and the impacted colloidal suspension is impacted upon the impact wall.

17. The method of claim 14, wherein the impact wall has a surface that is either flat or includes one or more surface imperfections formed therein.

18. A method for reducing a total suspended solids concentration of a fluid, comprising:
impacting a first stream of the colloidal suspension having a first total suspended solids concentration with either (1) an impact wall, (2) one or more additional fluid streams, or (3) one or more additional fluid streams to form a combined stream and impacting the combined stream into the impact wall, to form an impacted colloidal suspension;
collecting the impacted colloidal suspension; and
separating a clarified fluid fraction from the collected impacted colloidal suspension, wherein the clarified fluid fraction has a second total suspended solids concentration less than the first total suspended solids concentration.

19. The method of claim 18, wherein the impact wall has a surface that is either flat or includes one or more surface imperfections formed therein.

20. The method of claim 18, wherein an angle of the first stream relative to an angle of the one or more additional fluid streams is less than 180 degrees.
